(19) United States
(12) Patent Application Publication
(10) Pub. No.: US 2009/0199723 A1
(43) Pub. Date: Aug. 13, 2009

(54) Tray Handler For Food Warming Apparatus

(75) Inventors: Loren J. Veltrop, Chicago, IL (US); Robert Long, Glenview, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: PRINCE CASTLE, INC., Carol Stream, IL (US)

(21) Appl. No.: 12/029,979

(22) Filed: Feb. 12, 2008

(51) Int. Cl. A47J 43/00; A47J 47/20; B65D 1/34; A47F 5/00; B65G 65/00

(52) U.S. Cl. 99/427; 211/126.15; 206/557; 211/162; 414/804

(57) ABSTRACT

A food warming apparatus has a heating compartment for maintaining previously cooked food portions in a ready-to-use condition. The food portions are contained in a tray that is placed in a tray handler. The tray handler may include a frame for receiving the tray, a handle, and rollers. A tray handler guide in the heating compartment has a guide surface on which the rollers are able to roll and stops for engaging the rollers at a maintenance position and an access position. In the maintenance position, the tray is positioned inside the heating compartment so that the food portions are maintained in a ready-to-use condition. In the access position, a user is able to access food portions in the tray. At the maintenance and access positions, the user may sense the engagement of the rollers by sensing that the tray handler's motion is impeded but not prevented.

### BACKGROUND OF THE INVENTION

1. Field of the Invention

This invention relates to the field of food preparation. More particularly, this invention relates to an apparatus and method for maintaining food in a ready to use condition in which previously cooked food portions contained in a tray supported by a tray handler.

2. Description of Related Art

In many establishments, such as fast food restaurants, certain food items are cooked well in advance of when they are ordered by or served to the customer. Examples of such food items can include sandwich fillings, such as cooked eggs, hamburger patties, breaded foods, such as chicken nuggets, or balked goods, such as muffins. These previously cooked food portions are often maintained in a ready-to-use condition until they served to the customer. This typically involves maintaining the previously cooked food portions at a serving temperature in the range of from about 140° F. to about 200° F., depending on the food item.

Various food warming apparatus have been developed to maintain previously cooked food portions at a desired serving temperature. Such food warming apparatus are sometimes referred to as staging cabinets, holding cabinets, or warming cabinets. Some of the challenges involved in designing a food warming apparatus involve increasing the safety of the apparatus and reducing spillage while maintaining a speedy workflow within the restaurant.

In this regard, containers such as trays are often used to hold previously cooked food portions in a food warming apparatus. However, due to the holding temperatures often used, such trays can become too hot for users to touch directly. This, in turn, can create safety concerns and can cause difficulties in meeting the efficiency demands of many high-volume restaurants.

### SUMMARY

In a first principal aspect, an exemplary embodiment provides a food warming apparatus for maintaining previously cooked food portions in a ready-to-use condition. The food warming apparatus comprises a cabinet having at least one heating compartment therein, at least one tray for holding the previously cooked food portions, and at least one tray handler disposed in the at least one heating compartment. The at least one tray handler includes a frame for receiving the at least one tray, at least one handle, and at least one roller. A user is able to move the at least one tray by manually grasping the at least one handle and rolling the at least one tray handler on the least one roller within the at least one heating compartment.

In a second principal aspect, a food warming apparatus comprises a cabinet having at least one heating compartment therein, at least one tray handler that is able to move in at least a forward direction and a rearward direction in the at least one heating compartment, at least one tray for holding previously cooked food portions and disposed in the at least one tray handler, and at least one engagement structure disposed in the heating compartment. The at least one engagement structure is configured to engage the at least one tray handler, so as to impede but not prevent forward and rearward motion of the at least one tray handler, when the tray handler is in a maintenance position and when the at least one tray handler is in an access position. The maintenance position is a position in which the at least one tray is inside the heating compartment to allow the food warming apparatus to maintain previously cooked food portions contained in the at least one tray in a ready-to-use condition. The access position is a position in which the at least one tray is at least partially withdrawn from the heating compartment to allow a user to access previously cooked food portions contained in the at least one tray.

In a third principal aspect, an exemplary embodiment provides a method for moving a tray in a food warming apparatus. The tray contains previously cooked food portions. The food warming apparatus contains a heating compartment. The tray is supported in a tray handler. The tray handler is able to move in at least a forward direction and a rearward direction in the heating compartment. The tray handler is moved to a maintenance position by moving the tray handler in the rearward direction until the tray handler's movement is impeded but not prevented by a first engagement between the tray handler and at least one engagement structure disposed in the heating compartment. The maintenance position is a position in which the tray is inside the heating compartment to allow the food warming apparatus to maintain previously cooked food portions contained in the tray in a ready-to-use condition. The tray is moved to an access position by moving the tray handler in the forward direction until the tray handler's movement is impeded but not prevented by a second engagement between the tray handler and the at least one engagement structure. The access position is a position in which the tray is at least partially withdrawn from the heating compartment to allow a user to access previously cooked food portions contained in the tray. The tray handler is moved out of the maintenance position by overcoming the first engagement. The tray handler is moved out of the access position by overcoming the second engagement.

### BRIEF DESCRIPTION OF THE DRAWINGS

FIG. 1 is an isometric view of a food warming apparatus containing four trays in four tray handlers, in accordance with an exemplary embodiment.

FIG. 2 is an isometric view of the food warming apparatus of FIG. 1, with all of the trays and two of the tray handlers removed, in accordance with an exemplary embodiment.

FIG. 3 is an isometric view of a tray handler without a tray, in accordance with an exemplary embodiment.

FIG. 4 is an isometric view of the tray handler of FIG. 3, with a tray disposed therein, in accordance with an exemplary embodiment.

### DETAILED DESCRIPTION OF EXEMPLARY EMBODIMENTS

### 1. Overview

A food warming apparatus is able to maintain previously cooked food portions in a ready-to-use condition. The previously cooked food portions may be placed in one or more open-top containers, which are referred to herein as “trays.” The trays containing the previously cooked food portions may be placed in one or more heating compartments to maintain the portions at a desired temperature.

A tray may be disposed in a tray handler in order to facilitate movement of the tray within a heating compartment. An exemplary tray handler includes a frame for receiving the tray, one or more rollers that permit the tray to roll, and a handle that can be grasped by the user to roll the tray without touching a hot surface.

A roller may be a wheel or, alternatively, a roller could include one or more ball bearings, such as a ball bearing slide or caster. Alternatively, instead of rollers, a tray handler may be supported by one or more a low-friction elements (e.g., legs or protrusions) that enable the tray handler to move within the heating compartment by sliding.

The handle may extend out of the open front or open back of a heating compartment so to be cool enough to be grasped by a user's hand. For further safety, a handle may have an insulating sheath. By pulling on the handle the user may at least partially withdraw the tray handler (and the tray with it) through the open front or back of the heating compartment. The user may put the tray back inside the heating compartment by pushing on the handle.

One or more tray handler guides may be placed in a heating compartment to provide a generally flat, horizontal guide surface. The tray handler is able to move on the guide surface (e.g., by rolling or sliding) in a forward direction and in a rearward direction within the heating compartment. One or more stops may be formed in the tray handler guide. A stop may engage a tray handler so as to impede but not prevent movement of the tray handler at a fixed point along the tray handler guide. A stop could be, for example, an opening in the guide surface. The opening may engage the tray handler when a roller or other component of the tray handler drops into the opening. Alternatively, a stop may be a bump on the tray handler guide or some other type of engagement structure that is configured to engage the tray handler.

When a stop or other engagement structure is in engagement with the tray handler, a user may overcome the engagement by applying addition force, such as by pushing or pulling on the tray handler. For example, a tray handler may be pushed or pulled so as to lift a roller on the tray handler out of an opening in the guide surface, thereby overcoming the engagement. Once the engagement is overcome, less force may be required to continue moving the tray handler away from the point of engagement, i.e., in either the forward direction or rearward direction.

The one or more stops may be arranged in a tray handler guide so as to engage the tray handler in a maintenance position and in an access position. The maintenance position may be a position where the tray is substantially inside the heating compartment, thereby allowing the food warming apparatus to maintain previously cooked food portions in the tray in a ready-to-use condition. The access position may be a position where the tray is at least partially withdrawn from the heating compartment that allows a user to have convenient access to the tray, either to remove previously cooked food portions from the tray or to add previously cooked food portions to the tray.

In operation, a user may place a tray containing previously cooked food portions in a tray handler. The user may then move the tray handler to the maintenance position by pushing the tray handler into the heating compartment until the tray handler is engaged by a stop or other engagement structure. The user may sense the engagement by sensing that the tray handler's movement has been impeded. The user may subsequently move the tray handler from the maintenance position to the access position. To do this, the user may pull on the tray handler with sufficient force to overcome the engagement and then continue pulling the tray handler until the user senses an engagement at the access position. Later on, the user may push on the tray handler to overcome the engagement at the access position and then continue pushing the tray handler toward the maintenance position. In this way, the engagement between the engagement structures in the heating compartment and the tray handler may allow the user to sense when the tray is in the desired maintenance or access position.

### 2. Exemplary Food Warming Apparatus

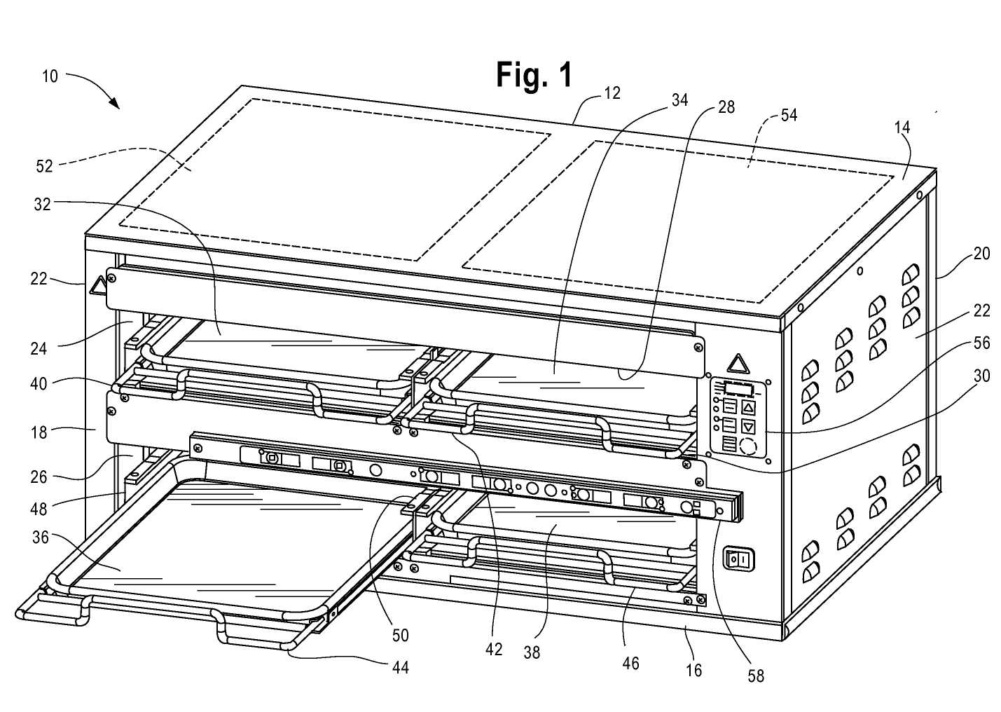

With reference to FIG. 1, an exemplary food warming apparatus 10 includes a housing or cabinet 12 that has a top 14, a bottom 16, a front 18, a back 20, and sides 22. The interior of cabinet 12 is divided into heating compartments 24 and 26. Although FIG. 1 shows an exemplary food warming apparatus 10 with two heating compartments, it is to be understood that a food warming apparatus could be provided with a greater or fewer number of heating compartments.

In the example shown in FIG. 1, front 18 is open to provide access to compartments 24 and 26. However, it is to be understood that back 20 could also be open to provide access to compartments 24 and 26, for example, in a pass-through configuration. Each of compartments 24 and 26 includes an upper compartment surface and a lower compartment surface. Thus, compartment 24 includes an upper compartment surface 28 and a lower compartment surface 30, as shown in FIG. 1. Compartment 26 may be similarly configured.

Each of compartments 24 and 26 is sized to accommodate one or more trays, as exemplified in FIG. 1 by trays 32 and 34 in compartment 24 and trays 36 and 38 in compartment 26. Although FIG. 1 shows two trays in each compartment, it is to be understood that the compartments may be sized to accommodate a greater or fewer number of trays. In addition, although FIG. 1 shows each compartment filled with its maximum number of trays, it is to be understood that a compartment might hold less than the maximum number of trays at any given time.

In each compartment, trays may be received in tray handlers. For example, FIG. 1 shows trays 32, 34, 36, and 38 in tray handlers 40, 42, 44, and 46 respectively. A tray handler may be disposed in a compartment in various ways. For example, a tray handler could rest on the lower compartment surface. Alternatively, a tray handler could rest on one or more tray handler guides. In the example illustrated in FIG. 1, each tray handler in each compartment is supported above the lower compartment surface by two tray handler guides. For example, tray handler 44 is supported by tray handler guides 48 and 50.

Each of compartments 24 and 26 may be heated by a respective heating system. In an exemplary embodiment, each heating system includes one or more resistive heaters for heating its respective compartment from above and/or from below. For example, compartment 24 may be heated through upper compartment surface 28 by heater plates 52 and 54 which may be positioned over trays 32 and 34, respectively. Compartment 24 may also be heated through lower compartment surface 30 by similar heater plates. Compartment 26 may be heated in a similar manner.

Food warming apparatus 10 may include various controls for enabling an operator to control its operation and various indicators for displaying information to the operator. Some of the controls and indicators may be arranged in a control panel 56 disposed on front 18. Other controls and indicators may be arranged in an interface bar 58.

Control panel 56 may enable the operator to select setpoint temperatures for the compartment (or for specific trays in the compartments). A control system in food warming apparatus 10 may control the heating systems for the compartments (e.g., thermostatically) so as to achieve and maintain the setpoint temperatures. In an exemplary embodiment, the control system may measure the temperature at the heating system (e.g., at heater plate 52 or 54), so that the setpoint temperature corresponds to the temperature at the heating system. The temperature of the food inside of the covered tray in the compartment may be lower than the setpoint temperature. For example, it may be desirable to maintain previously cooked food portions at a temperature that may range from about 140° F. to about 200° F. To achieve this food temperature, the setpoint temperature may need to be as high as 400° F.

Interface bar 58 may enable an operator to select a hold time for the respective compartment (or for a specific tray in the compartment) based, for example, on the particular food product contained in the compartment (or contained in a specific tray in the compartment). The operator may select the hold time by scrolling through a list of food products, each of which has been associated with a preset hold time. A display on the interface bar may display descriptions of the food products as the operator scrolls through the list and may then display a description of the selected food product.

When the selected food product is placed in the compartment, the operator may interact with the compartment's interface bar to start a timer. When the hold time has been reached, the compartment's interface bar may provide an indication to the operator. The operator may then replace the food product with fresh food product and interact with the interface bar to re-set the timer.

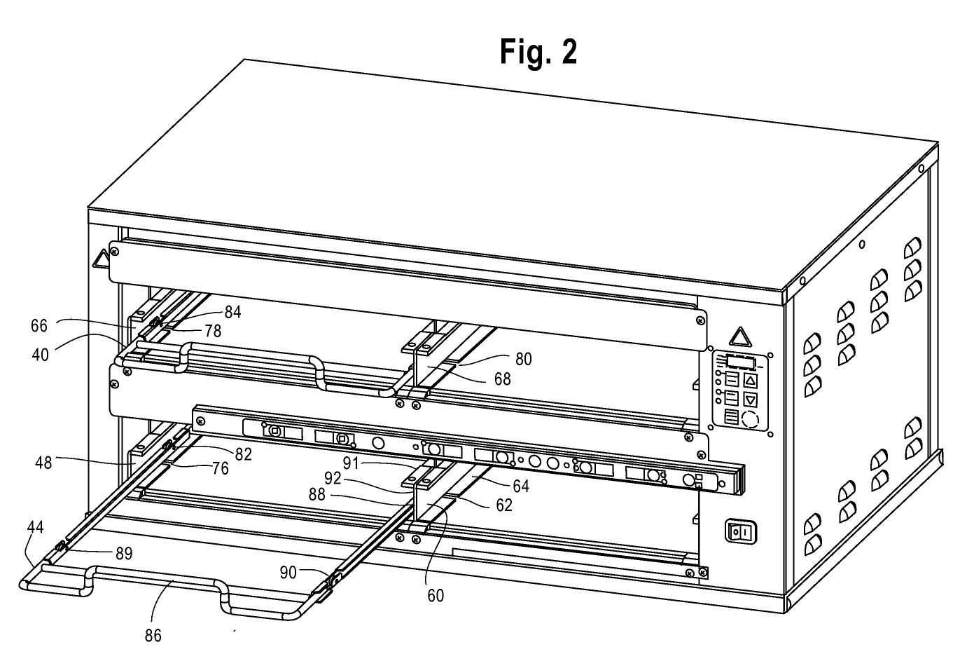

FIG. 2 shows the food warming apparatus 10 with trays 32, 34, 36, and 38 and tray handlers 42 and 46 removed, leaving tray handlers 40 and 44. A portion of tray handler guide 60 is visible, showing stop 62 as a gap in the flat horizontal guide surface 64 of tray handler guide 60. While stop 62 is shown as a gap in the flat horizontal guide surface, stop 62 could be some other type of aperture, cavity, opening, hole, indentation, or interruption in the guide surface. Alternatively, stop 62 could be a bump, bulge, knob, ramp, block, or other protuberance in the guide surface. Further, stop 62 could be either in the flat horizontal guide surface 64 or on the remainder of tray handler guide 60. FIG. 2 also shows stops 76, 78, and 80 for tray handler guides 48, 66, and 68 respectively.

FIGS. 1 and 2 show tray handler 44 partially withdrawn from the food warming apparatus 10. This position is an access position, i.e., a position where tray 36 in tray handler 44 is partially withdrawn from heating compartment 26, thereby allowing a user to access previously cooked food portions contained in tray 36. In this access position, roller 82 of tray handler 44 is shown engaged by stop 76. This engagement tends to keep tray handler 44 in the access position. However, tray handler 44 can still be moved from this position with additional effort.

FIGS. 1 and 2 show tray handler 40 positioned inside of food warming apparatus 10. This position is a maintenance position, i.e., a position where tray 32 in tray handler 44 is inside of heating compartment 24 so that food warming apparatus 10 is able to maintain previously cooked food portions contained in tray 32 in a ready-to-use condition. In this maintenance position, roller 84 of tray handler 40 engaged by stop 78. This engagement tends to keep tray handler 40 in the maintenance position. However, tray handler 40 can still be moved from this position with additional effort.

In this example, a stop engages a roller on a tray handler. However, it is to be understood that a stop could engage other structures on a tray handler so as to impede without preventing the tray handler's motion.

### 3. Exemplary Tray Handler

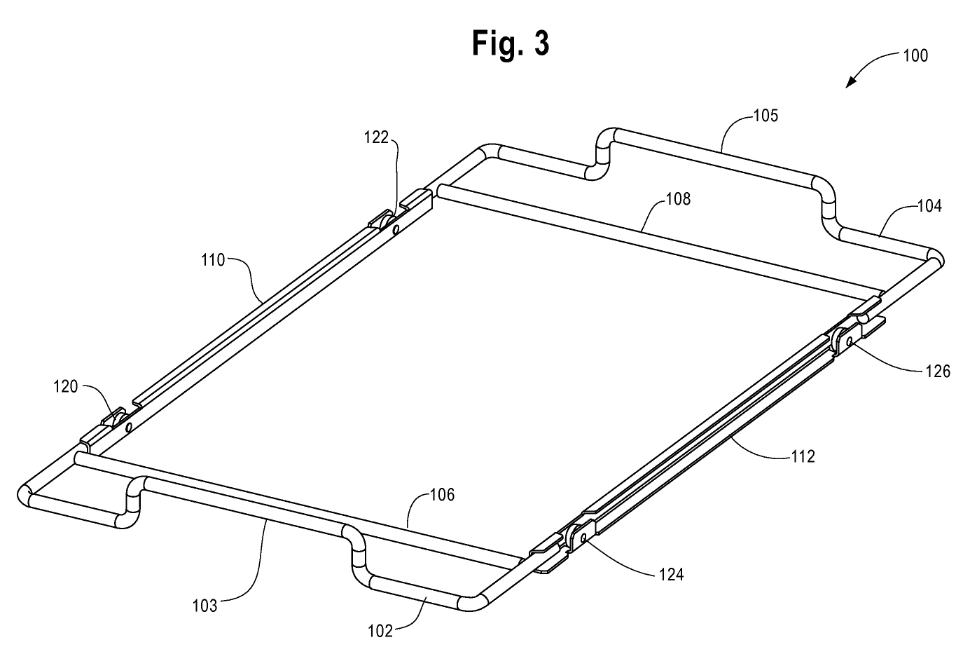

An exemplary tray handler 100 is shown in FIG. 3, without a tray. The exemplary tray handler has a front member 102 and rear member 104. In the exemplary tray handler, the front member 102 is shaped into a front handle 103 that extends from the rest of the tray handler and allows a user to move the tray handler into or out of the front of a heating compartment without burning the user. Similarly, the rear member 104 is shaped into a rear handle 105 that extends from the rest of the tray handler to allow a user to move the tray handler into or out of the back of a heating compartment without burning the user. A handle could be covered with an insulating sheath to provide further protection to the user against heat. An insulating sheath could be made of plastic, fiberglass, or other materials that could provide sufficient heat protection for a user. Alternatively, instead of having a handle formed into a tray handler, a handle may be removably attached to a tray handler. In another embodiment, the tray itself could be shaped into a handle.

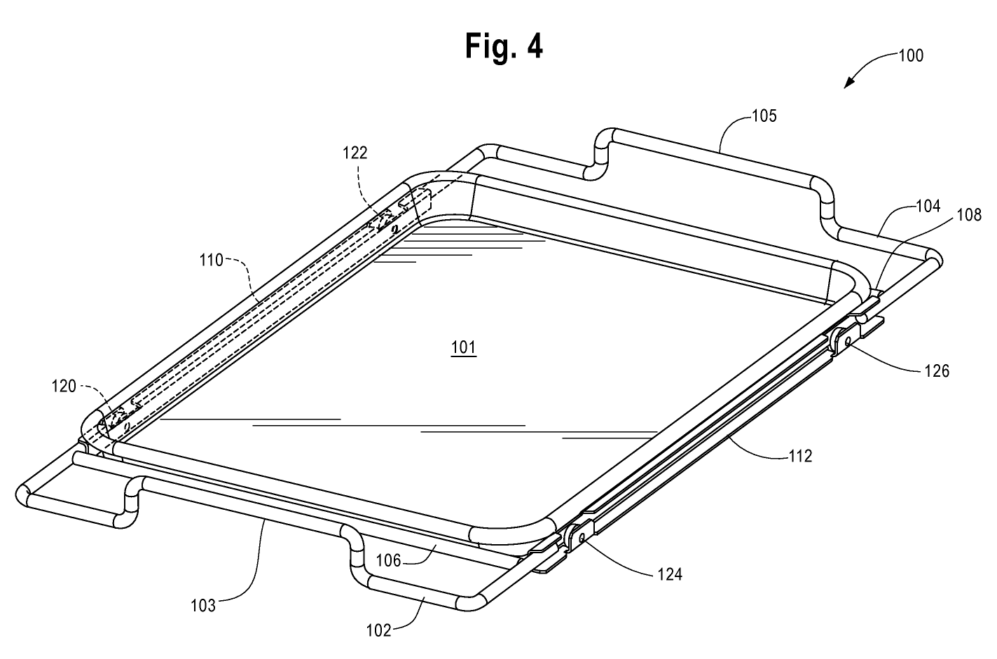

In FIG. 4, a tray 101 is received within a frame of an exemplary tray handler 100. In tray handler 100, the frame comprises supports 106, 108, 110, and 112, as well as front member 102 and rear member 104. It is to be understood, however, that the frame could include either a greater or fewer number of components. In some cases, tray 101 may rest directly on the supports 106, 108, 110, and 112 of the frame. Alternatively, tray 101 may rest on the lower compartment surface in a heating compartment but surrounded by the frame so that tray 101 may be moved by moving tray handler 100. In another embodiment, a tray support surface could be attached to the supports and the tray could rest on the tray support surface. The tray and tray handler could be made of a metal or high-temperature plastic that is suitable for holding the previously cooked food portions and enduring the temperatures inside the heating compartment.

Returning to FIG. 3, in an exemplary tray handler, the side supports 110 and 112 are fashioned to allow rollers 120, 122, 124, and 126 to be fastened to the tray handler. While four rollers are shown in the exemplary tray handler, it is understood that fewer or more rollers could be used. In an exemplary tray handler, the rollers 120, 122, 124, and 126 are wheels. In other embodiments, one or more rollers could be made of ball bearing rollers, ball bearing slides, casters, or similar devices that would permit the tray handler to move smoothly. Instead of rollers, a tray handler could be provided with one or more low-friction surfaces to allow the tray handler to move smoothly within the heating compartment.

### 4. Exemplary Method of Use

To use food warming apparatus 10, a user may place a tray containing previously cooked food portions in a tray handler. The tray handler may already be in a heating compartment, or the tray handler with the tray received therein may be inserted into the heating compartment. For example, tray handler 44 may be positioned on tray handler guides 48 and 88 that are mounted within heating compartment 26, as shown in FIG. 2. Tray handler guides 48 and 88 may have openings 76 and 92 therein, respectively, which may function as stops. A user may then place tray 36 containing previously cooked food portions in tray handler 44 to attain the configuration shown in FIG. 1.

To keep the previously cooked food portions in tray 36 in a ready-to-use condition, a user can move tray 36 to a maintenance position in heating compartment 26. The user may move tray 36 to the maintenance position by rolling tray handler 44 along tray handler guides 48 and 88, using rollers 82, 89, 90, and 91, until rollers 89 and 90 drop into openings 76 and 92, respectively, so as to engage tray handler 44 with tray 36 therein at the proper maintenance position. The user may sense this engagement by sensing that the motion of tray handler 44 has been impeded. To reach the maintenance position from the configuration shown in FIG. 1, the user may push tray handler 44 into heating compartment 26 by handle 86.

To remove previously cooked food portions from tray 36, a user may move tray handler 44 with tray 36 received therein from the maintenance position to an access position (i.e., the position illustrated in FIG. 1). To reach the access position, the user may roll tray handler 44 along tray handler guides 48 and 88 by pulling on handle 86 until rollers 82 and 91 drop into openings 76 and 92, respectively, so as to engage tray handler 44 with tray 36 therein at the proper access position. The user may sense this engagement by sensing that the motion of tray handler 44 has been impeded.

Tray handler 44 can still be moved when engaged in the maintenance or access position. To move overcome the engagement, additional effort could be applied to tray handler 44 so that rollers 89 and 90 (in the maintenance position) or rollers 82 and 91 (in the access position) lift out of openings 76 and 92.

Although FIGS. 1 and 2 show the use of tray handler 44 from the front of heating compartment 26, tray handler 44 could also be access from the back of heating compartment if back 20 is also open.

### 5. Conclusion

While certain features and embodiments of the present invention have been described in detail herein, it is to be understood that the invention encompasses all modifications and enhancements within the scope and spirit of the following claims.

What is claimed is:

1. A food warming apparatus for maintaining previously cooked food portions in a ready-to-use condition, the food warming apparatus comprising:
a cabinet having at least one heating compartment therein;
at least one tray for holding the previously cooked food portions;
at least one tray handler disposed in the at least one heating compartment, the at least one tray handler comprising:
a frame for receiving the at least one tray;
at least one handle; and
at least one roller,
whereby a user is able to move the at least one tray by manually grasping the at least one handle and rolling the at least one tray handler on the least one roller within the at least one heating compartment.

2. The apparatus of claim 1, further comprising:
at least one tray handler guide disposed in the at least one heating compartment, wherein the at least one tray handler guide comprises a generally flat, horizontal guide surface and the at least one tray handler is able to move by rolling the at least one roller on the guide surface.

3. The apparatus of claim 2, wherein the at least one tray handler guide further comprises:
at least one stop for engaging the at least one roller, wherein the at least one stop impedes but does not prevent movement of the at least one tray handler at a fixed point along the at least one tray handler guide.

4. The apparatus of claim 3, wherein the at least one stop engages the at least one roller when the at least one tray handler is in an access position, the access position being a position in which the at least one tray is at least partially withdrawn from the heating compartment to allow a user access to previously cooked food portions contained in the tray.

5. The apparatus of claim 3, wherein the stop engages the at least one roller when the at least one tray handler is in a maintenance position, the maintenance position being a position in which the at least one tray is inside the heating compartment to allow the food warming apparatus to maintain previously cooked food portions contained in the tray in a ready-to-use condition.

6. The apparatus of claim 3, wherein the at least one stop comprises at least one opening in the guide surface.

7. A food warming apparatus comprising:
a cabinet having at least one heating compartment therein;
at least one tray handler that is able to move in at least a forward direction and a rearward direction in the at least one heating compartment;
at least one tray for holding previously cooked food portions, wherein the at least one tray is disposed in the at least one tray handler; and
at least one engagement structure disposed in the heating compartment, wherein the at least one engagement structure is configured to engage the at least one tray handler, so as to impede but not prevent forward and rearward motion of the at least one tray handler, when the at least one tray handler is in a maintenance position and when the at least one tray handler is in an access position, the maintenance position being a position in which the at least one tray is inside the heating compartment to allow the food warming apparatus to maintain previously cooked food portions contained in the at least one tray in a ready-to-use condition, the access position being a position in which the at least one tray is at least partially withdrawn from the heating compartment to allow a user to access previously cooked food portions contained in the at least one tray.

8. The food warming apparatus of claim 7, further comprising:
a tray handler guide having a generally flat, horizontal guide surface, wherein the at least one tray handler is able to move along the guide surface.

9. The food warming apparatus of claim 8, wherein the at least one engagement structure comprises at least one stop in the guide surface.

10. The food warming apparatus of claim 9, wherein the at least one tray handler comprises at least a first roller and a second roller, and wherein the at least one tray handler is able to move along the guide surface by rolling on the first and second rollers.

11. The food warming apparatus method of claim 10, wherein at least one stop engages the first roller when the at least one tray handler is in the maintenance position.

12. The food warming apparatus of claim 11, wherein the at least one stop engages the second roller when the at least one tray handler is in the access position.

13. The food warming apparatus of claim 12, wherein the at least one stop comprises an opening in the guide surface.

14. The food warming apparatus of claim 13, wherein the first roller drops into the opening when the at least one tray handler reaches the access position, and wherein the second roller drops into the opening when the at least one tray handler reaches the maintenance position.

15. A method for moving a tray in a food warming apparatus, the tray containing previously cooked food portions, the food warming apparatus containing a heating compartment, the method comprising:
placing the tray in a tray handler, wherein the tray handler is able to move in at least a forward direction and a rearward direction in the heating compartment;
moving the tray handler to a maintenance position by moving the tray handler in the rearward direction until the tray handler's movement is impeded but not prevented by a first engagement between the tray handler and at least one engagement structure disposed in the heating compartment, the maintenance position being a position in which the tray is inside the heating compartment to allow the food warming apparatus to maintain previously cooked food portions contained in the tray in a ready-to-use condition;
moving the tray handler to an access position by moving the tray handler in the forward direction until the tray handler's movement is impeded but not prevented by a second engagement between the tray handler and the at least one engagement structure, the access position being a position in which the tray is at least partially withdrawn from the heating compartment to allow a user to access previously cooked food portions contained in the tray;
moving the tray handler out of the maintenance position by overcoming the first engagement; and
moving the tray handler out of the access position by overcoming the second engagement.

16. The method of claim 15, wherein moving the tray handler comprises:
moving the tray handler along a generally flat, horizontal guide surface in the heating compartment.

17. The method of claim 16, wherein the at least one engagement structure comprises at least one stop in the guide surface, and wherein the tray handler comprises at least a first roller and a second roller that allow the tray handler to roll on the guide surface.

18. The method of claim 17, wherein moving the tray handler to a maintenance position comprises rolling the tray handler on the guide surface until the at least one stop engages the first roller, and wherein moving the tray handler to an access position comprises rolling the tray handler on the guide surface until the at least one stop engages the second roller.

19. The method of claim 18, wherein the at least one stop comprises an opening in the guide surface.

20. The method of claim 19, wherein rolling the tray handler on the guide surface until the at least one stop engages the first roller comprises rolling the tray handler on the guide surface until the first roller drops into the opening, and wherein rolling the tray handler on the guide surface until the at least one stop engages the second roller comprises rolling the tray handler on the guide surface until the second roller drops into opening.

21. The method of claim 20, wherein overcoming the first engagement comprises pulling the tray handler so that the first roller lifts out of the opening, and wherein overcoming the second engagement comprises pushing the tray handler so that the second roller lifts out of the opening.
